(19) United States
(12) Patent Application Publication
(10) Pub. No.: US 2025/0020845 A1
(43) Pub. Date: Jan. 16, 2025

(54) WIRE-GRID POLARIZER, MANUFACTURING METHOD THEREFOR, AND OPTICAL DEVICE

(71) Applicant: Dexerials Corporation, Shimotsuke-Shi (JP)

(72) Inventor: Yuki Takahashi, Shimotsuke-Shi (JP)

(73) Assignee: Dexerials Corporation, Shimotsuke-Shi (JP)

(21) Appl. No.: 18/711,558

(22) PCT Filed: Dec. 20, 2022
(86) PCT No.: PCT/JP2022/046894

§ 371 Date: May 17, 2024

(30) Foreign Application Priority Data
Jan. 26, 2022 (JP) 2022-009939

(51) Int. Cl. G02B 5/30; G02F 1/1335; G03B 21/20

(52) U.S. Cl. CPC G02B 5/3058; G02F 1/133548; G03B 21/2073

(57) ABSTRACT

Provided is a wire-grid polarizer comprising: a transparent substrate; and lattice-shaped protrusions which, on one surface of the transparent substrate, extend in prescribed direction and are arrayed at a pitch which is shorter than the wavelength of light in a band to be used. The lattice-shaped protrusions each include, in order from the transparent substrate side, the following: a reflective layer; a dielectric layer; and an absorption layer. In a prescribed region of the transparent substrate, a region is provided in which the lattice-shaped protrusions are divided.

### TECHNICAL FIELD

The present invention relates to a wire grid polarizing element, a manufacturing method therefore, and an optical device.

### BACKGROUND ART

A polarizing element is an optical element which absorbs polarized light in a predetermined direction, and transmits polarized light perpendicular to this. In a liquid crystal display device, a polarizing element is required in principle. In particular, in a liquid crystal display device using a light source with a large amount of light such as a transmissive liquid crystal projector, the polarizing element is required to have heat resistance and light stability due to receiving strong radiant rays, and a size on the order of several centimeters, high extinction ratio and control over the reflectance characteristics are required. In order to meet these demands, a wire grid polarizing element has been proposed.

The wire grid polarizing element includes a transparent substrate, and latticed projections which are arranged at a pitch (tens of nanometers to hundreds of nanometers) shorter than the wavelength of light in the usage band on one side of the transparent substrate, and extending in a predetermined direction. Herein, the latticed projections include, in order from a side of the transparent substrate, a reflection layer, a dielectric layer and an absorption layer. When light is incident on this element, the s polarized light (TE wave (s wave)) having an electric field component parallel to the extending direction of the latticed projection cannot permeate, and the p polarized light (TM wave (p wave)) having an electric field component perpendicular to the extending direction of the latticed projection permeates.

The wire grid polarizing element is superior in heat resistance property and light stability, can be fabricated into a relatively large element, and has high extinction ratio. In addition, due to control of the reflectance characteristics also being possible by establishing as a multi-layer structure, and reducing deterioration in image quality by ghosting or the like, occurring by return light reflected by the surface of the element being reflected again into the device, it is suited to a liquid crystal projector.

In recent years, high brightness has been achieved in liquid crystal projectors, by establishing high luminous flux using a plurality of semiconductor lasers (LD) as the light source. For this reason, the wire grid polarizing elements are demanded to have light stability and transmittance characteristics, even under a high luminance environment.

Patent Document 1 discloses using a reflection layer having a metal layer and an oxide layer covering a lateral surface of the metal layer.

### CITATION LIST

### Patent Document

Patent Document 1: PCT International Publication No. WO2017/073044

### DISCLOSURE OF THE INVENTION

### Problems to be Solved by the Invention

However, if the latticed projections of the wire grid polarizing element collapse, it has a great impact on the optical properties and appearance quality.

The present invention has an object of providing a wire grid polarizing element which, even if the latticed projections collapse, is capable of reducing the influence on optical properties and appearance quality.

### Means for Solving the Problems

An aspect of the present invention provides a wire grid polarizing element including a transparent substrate; and latticed projections arranged at a pitch shorter than a wavelength of light of a usage band on one surface of the transparent substrate, and extending in a predetermined direction, in which the latticed projection includes, in order from a side of the transparent substrate, a reflection layer, a dielectric layer and an absorption layer, and in which a region which divides the latticed projection is disposed in a predetermined region of the transparent substrate.

The transparent substrate may be transparent to light of the usage band, and include glass, crystal, quartz or sapphire.

The reflection layer may contain at least one metal selected from the group consisting of Al, Ag, Cu, Mo, Cr, Ti, Ni, W, Fe, Si, Ge, Te and Nd.

The dielectric layer may include a Si oxide, a Ti oxide, a Zr oxide, an Al oxide, a Nb oxide or a Ta oxide.

The absorption layer may absorb light of the usage band, and contain a metal, alloy or semiconductor.

The above wire grid polarizing element may further include an antireflection layer on another surface of the transparent substrate.

In the above wire grid polarizing element, at least part of a surface may be covered by a protective film. In this case, the protective film may include a material which is the same as the material included in the dielectric layer.

In the above wire grid polarizing element, at least part of a surface may be covered by an organic water-repellent film.

Another aspect of the present invention provides a manufacturing method for a wire grid polarizing element, including the steps of: forming a layered body, by laminating on one surface of a transparent substrate in order from a side of the transparent substrate, a reflection layer, a dielectric layer and an absorption layer; forming latticed projections arranged at a pitch shorter than a wavelength of light of a usage band, and extending in a predetermined direction, by selectively etching the layered body; and forming a region which divides the latticed projection in a predetermined region of the transparent substrate.

The above manufacturing method for a wire grid polarizing element may further include a step of forming an antireflection layer on another surface of the transparent substrate.

The above manufacturing method for a wire grid polarizing element may further include a step a step of covering at least part of the surface by a protective film. In this case, the protective film may include a material which is the same as the material included in the dielectric layer.

The above manufacturing method for a wire grid polarizing element may further include a step a step of covering a step of covering at least part of the surface by an organic water-repellent film.

Another aspect of the present invention provides an optical device which includes the above wire grid polarizing element.

### Effects of the Invention

According to the present invention, it is possible to provide a wire grid polarizing element which, even if the latticed projections collapse, is capable of reducing the influence on optical properties and appearance quality.

### BRIEF DESCRIPTION OF THE DRAWINGS

FIG. 1 is a cross-sectional schematic view showing an example of a wire grid polarizing element according to the present embodiment;

FIG. 2 is a perspective schematic view showing the wire grid polarizing element of FIG. 1;

FIG. 3 is a perspective schematic view showing an example of a state in which the latticed projections of the wire grid polarizing element in FIG. 1 have collapsed;

FIG. 4 is a perspective schematic view showing an example of a wire grid polarizing element in which the latticed projections have not been divided;

FIG. 5 is a perspective schematic view showing an example of a state in which the latticed projections of the wire grid polarizing element in FIG. 4 have collapsed;

FIG. 6 is a perspective schematic view showing a modified example of the wire grid polarizing element in FIG. 1;

FIG. 7 is a perspective schematic view showing a modified example of the wire grid polarizing element in FIG. 1;

FIG. 8 is a perspective schematic view showing a modified example of the wire grid polarizing element in FIG. 1; and

FIGS. 9A, 9B, 9C and 9D are perspective schematic views showing an example of a formation method of a mask pattern.

### PREFERRED MODE FOR CARRYING OUT THE INVENTION

Hereinafter, embodiments of the present invention will be explained while referencing the drawings.

### (Polarizing Element)

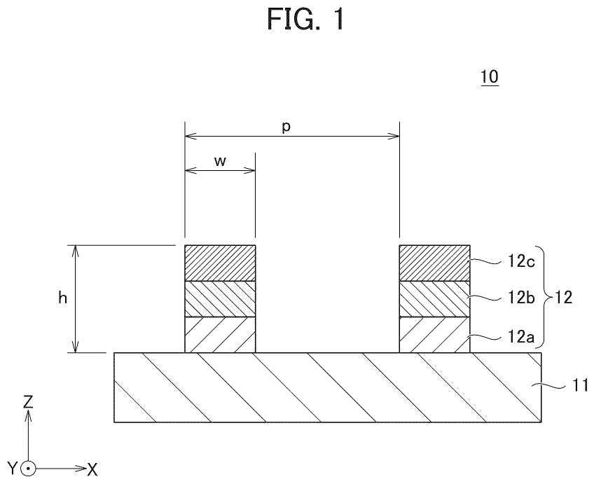

FIG. 1 shows an example of a wire grid polarizing element according to the present embodiment.

The wire grid polarizing element 10 includes: a transparent substrate 11, and latticed projections 12 of width w and height h extending in a Y-axis direction, arranged at a pitch p which is shorter than the wavelength of light in the used band, on one surface of the transparent substrate 11.

Herein, as shown in FIG. 1, the direction in which the latticed projection 12 extends is called the Y-axis direction. In addition, a direction in which the latticed projections 12 are arranged at pitch p along a main surface of the transparent substrate 11, and orthogonal to the Y-axis direction is called the X-axis direction. Furthermore, a direction orthogonal to the Y-axis direction and X-axis direction, and perpendicular to the main surface of the transparent substrate 11 is called the Z-axis direction. It should be noted that light incident on the wire grid polarizing element 10 may be incident from either side of the transparent substrate 11; however, it is preferably incident from the Z-axis direction on a side of the transparent substrate 11 on which the latticed projections 12 are formed (grid surface side).

The wire grid polarizing element 10, by adopting four effects of transmission, reflection, interference and selective light absorption of polarized light by optical anisotropy, attenuates s polarized light (TE wave (s wave)) having an electric field component parallel to the Y-axis direction, and transmits p polarized light (TM wave (p wave)) having an electric field component parallel to the X-axis direction. Therefore, in FIG. 1, the Y-axis direction is the direction of an absorption axis of the wire grid polarizing element 10, and the X-axis direction is a direction of the transmission axis of the wire grid polarizing element 10.

Herein, the height h indicates a dimension in the Z-axis direction perpendicular to the main surface of the transparent substrate 11. In addition, the width w, when viewing the wire grid polarizing element 10 from the Y-axis direction, indicates a dimension in the X-axis direction orthogonal to the height h. Furthermore, the pitch p is a repeating interval in the X-axis direction of the latticed projections 12, when viewing the wire grid polarizing element 10 from the Y-axis direction.

The pitch p is not particularly limited so long as shorter than the wavelength of light in the used band; however, from the viewpoint of ease of manufacture and stability of the wire grid polarizing element 10, for example, it is preferably at least 100 nm and no more than 200 nm. The pitch p can be measured by observing using a scanning electron microscope or a transmission electron microscope. For example, using a scanning electron microscope or a transmission electron microscope, it is possible to measure the pitch p at any four locations, and define the arithmetic mean value thereof as the pitch p. Hereinafter, this measurement method is called electron microscopy.

As shown in FIG. 1, the latticed projection 12 includes, in order from the side of the transparent substrate 11, a reflection layer 12a, dielectric layer 12b and absorption layer 12c. The latticed projections 12 have a wire grid structure arranged in a one-dimensional grid on one surface of the transparent substrate 11.

The light incident from the side of the transparent substrate 11 on which the latticed projections 12 are formed (grid surface side), is partially absorbed and attenuates, upon passing through the absorption layer 12c and dielectric layer 12b. Among the light transmitted through the absorption layer 12c and dielectric layer 12b, the p polarized light (TM wave (p wave)) transmits through the reflection layer 12a with high transmittance. On the other hand, among the light transmitted through the absorption layer 12c and dielectric layer 12b, the s polarized light (TE wave (s wave)) is reflected by the reflection layer 12a. The s polarized light reflected by the reflection layer 12a is partially absorbed upon passing through the dielectric layer 12b and absorption layer 12c; however, part is reflected and returns to the reflection layer 12a. In addition, the s polarized light reflected by the reflection layer 12a interferes and attenuates upon passing through the dielectric layer 12b and absorption layer 12c. In the above way, the grid wire polarizing element 10 can obtain the desired polarization property by the s polarized light being selectively attenuated.

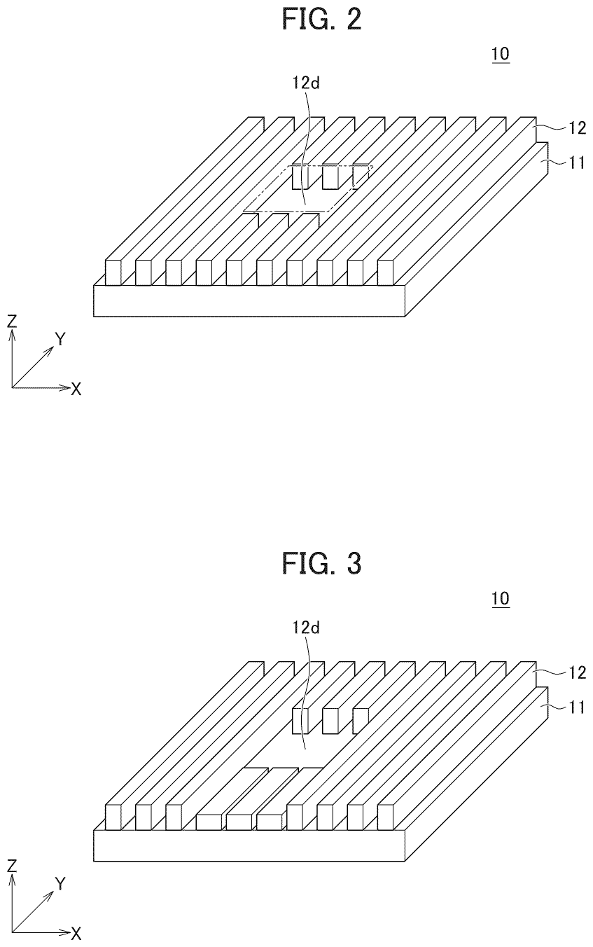

As shown in FIG. 2, in the wire grid polarizing element 10, a rectangular division region 12d which divides the latticed projections 12 is arranged at a central part of the transparent substrate 11. In other words, the latticed projections 12 are divided at a central part of the transparent substrate 11. For this reason, in the wire grid polarizing element 10, even if the latticed projections 12 on one side in the Y-axis direction are collapsed, relative to the division region 12d, since the latticed projections 12 on the other side in the Y-axis direction will not be collapsed (refer to FIG. 3), the influence on the optical properties and appearance quality is reduced.

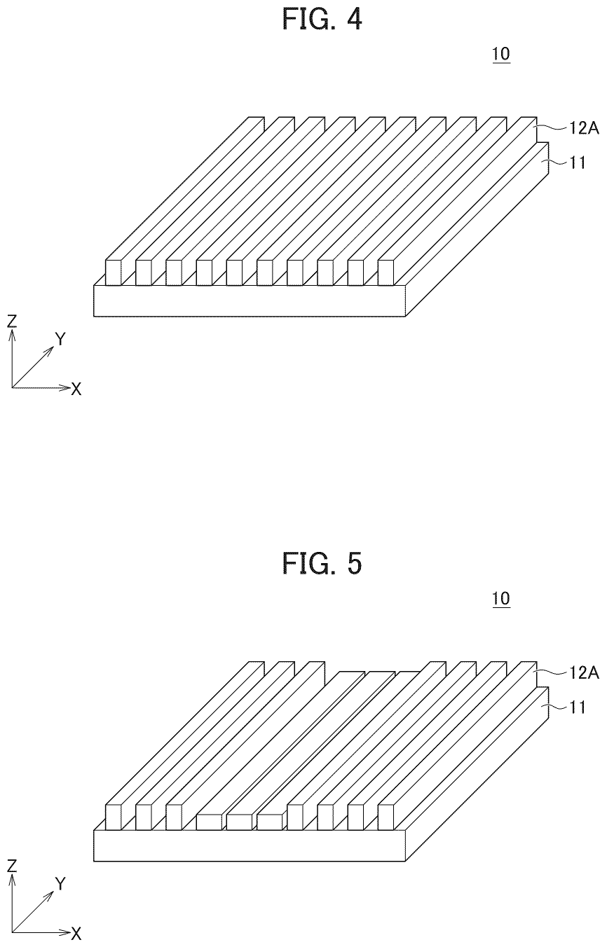

In contrast, as shown in FIG. 4, in the case of the latticed projection 12A not being divided, since the entire latticed projections 12A in the Y-axis direction are collapsed (refer to FIG. 5), the influence on the optical properties and appearance quality is great.

The size in the X-axis direction and Y-axis direction of the division region 12d is not particularly limited; however, it is at least 100 nm and no more than 1000 nm, for example. The density of the division region 12d is not particularly limited; however, it is on the order of 5×10³ per mm², for example.

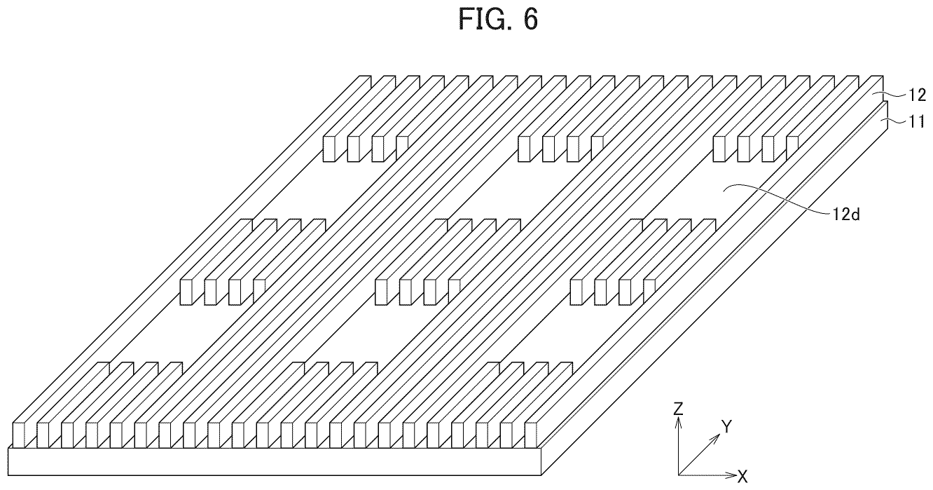

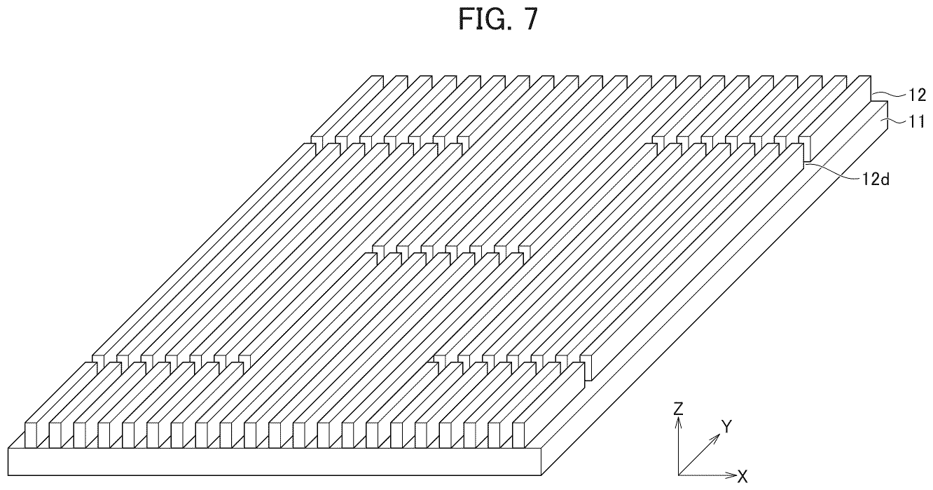

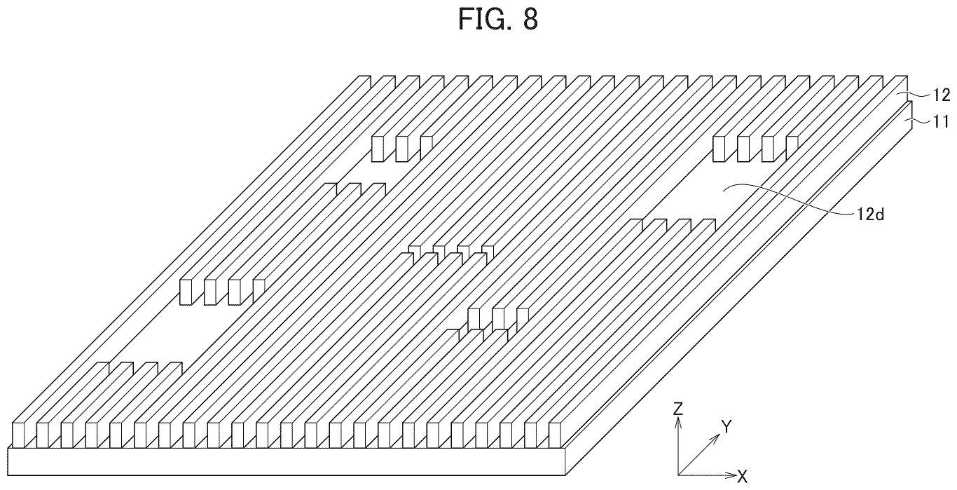

It should be noted that the division region 12d may not necessarily be arranged at the central part of the transparent substrate 11, for example, and may be arranged regularly at equal intervals in the transparent substrate 11 (refer to FIG. 6), or may be arranged irregularly in the transparent substrate 11. In addition, the shape of the division region 12d is not limited to rectangular, and may be a polygonal shape other than rectangular, circular, elliptical or linear (refer to FIG. 7), for example. Furthermore, a plurality of shapes may be jointly used as the shape of the division region 12d (refer to FIG. 8).

### (Reflection Layer)

The reflection layer 12a is arranged at the pitch p on one surface of the transparent substrate 11, and extends in the Y-axis direction. The reflection layer 12a has a function as a wire grid polarizer, attenuates the s polarized light (TE wave (s wave)) having an electric field component in a direction parallel to the extending direction of the reflection layer 12a, and transmits the p polarized light (TM wave (p wave)) having an electric field component in a direction orthogonal to the extending direction of the reflection layer 12a.

The material constituting the reflection layer 12a is not particularly limited so long as being a material having reflectivity to light of the usage band; however, for example, metals such as Al, Ag, Cu, Mo, Cr, Ti, Ni, W, Fe, Si, Ge, Te and Nd, and alloys containing at least one of these can be exemplified. Thereamong, Al or Al alloys are preferable.

It should be noted that the reflection layer 12a, for example, may be inorganic film or resin film other than a metal film having high reflectance of the surface due to colorant or the like.

The thickness of the reflection layer 12a is not particularly limited; however, it is preferably at least 100 nm and no more than 300 nm. It should be noted that the measurement method of thickness of the reflection layer 12a is not particularly limited; however, for example, electron microscopy and the like can be exemplified.

The formation method of the reflection layer 12a is not particularly limited; however, for example, a vapor deposition method, sputtering method and the like can be exemplified.

It should be noted that the reflection layer 12a may be a layered body of two or more layers having different constituting materials.

### (Dielectric Layer)

The dielectric layer 12b is formed on the reflection layer 12a. In other words, the dielectric layer 12b is arranged at the pitch p, and extends in the Y-axis direction.

The thickness of the dielectric layer 12b is set so as to be a range in which the phase of the s polarized light transmitting through the absorption layer 12c and reflecting by the reflection layer 12a is shifted by half wavelength, relative to the s polarized light reflected by the absorption layer 12c. More specifically, the thickness of the dielectric layer 12b is not particularly limited so long as able to adjust the phase of the s polarized light and enhance interference effect; however, for example, it is appropriately set in a range of at least 1 nm and no more than 500 nm. It should be noted that the measurement method of the thickness of the dielectric layer 12b is not particularly limited; however, for example, electron microscopy and the like can be exemplified.

The material constituting the dielectric layer 12b is not particularly limited; however, for example, Si oxide, Ti oxide, Zr oxide, Al oxide, Nb oxide, Ta oxide or the like can be exemplified.

The refractive index of the dielectric layer 12b is preferably greater than 1.0, and no more than 2.5. The optical properties of the reflection layer 12a are affected by the refractive index of the dielectric layer 12b; therefore, by selecting the material constituting the dielectric layer 12b, it is possible to control the optical properties of the wire grid polarizing element 10. In addition, by appropriately adjusting the thickness and refractive index of the dielectric layer 12b, the s polarized light reflected by the reflection layer 12a, upon penetrating the absorption layer 12c, can be partially reflected and return to the reflection layer 12a, and can attenuate the s polarized light having passed through the absorption layer 12c by interference. By configuring in this way, it is possible to obtain the desired polarization properties by selectively attenuating the s polarized light.

The formation method of the dielectric layer 12b is not particularly limited; however, for example, a vapor deposition method, sputtering method, CVD (Chemical Vapor Deposition) method, ALD (Atomic Layer Deposition) method, and the like can be exemplified.

It should be noted that the dielectric layer 12b may be a layered body of two or more layers having different material constituting.

### (Absorption Layer)

The absorption layer 12c is formed on the dielectric layer 12b. In other words, the absorption layer 12c is arranged at the pitch p, and extends in the Y-axis direction.

The thickness of the absorption layer 12c is not particularly limited; however, for example, it is preferably at least 5 nm and no more than 50 nm. It should be noted that the measurement method for the thickness of the absorption layer 12c is not particularly limited; however, for example, electron microscopy and the like can be exemplified.

The method constituting the absorption layer 12c is not particularly limited so long as material absorbing light of the usage band, i.e. extinction coefficient is not 0; however, metals, alloys, semiconductors, etc. can be exemplified. As the metal, for example, Ta, Al, Ag, Cu, Au, Mo, Cr, Ti, W, Ni, Fe, Sn and the like can be exemplified. As the alloy, for example, an alloy containing at least one type of metal among these metals can be exemplified. In addition, as the semiconductor, for example, Si, Ge, Te, ZnO, silicide materials (β-FeSi₂, MgSi₂, NiSi₂, BaSi₂, CrSi₂, CoSi₂, TaSi, etc.), and the like can be exemplified. In the wire grid polarizing element 10, a high extinction ratio in the visible light range is thereby obtained. Thereamong, the absorption layer 12c preferably contains Fe or Ta, as well as containing Si.

As the material constituting the absorption layer 12c, in the case of using a semiconductor, band gap energy of the semiconductor is involved in light absorption; therefore, it is necessary for the band gap energy of the semiconductor to be no more than the energy of light in the usage band. For example, in the case of the usage band being the visible light range, it is necessary to use a semiconductor which absorbs light having a wavelength of at least 400 nm, i.e. band gap energy no more than 3.1 eV.

The formation method of the absorption layer 12c is not particularly limited; however, for example, a vapor deposition method, sputtering method and the like can be exemplified.

It should be noted that the absorption layer 12c may be a layered body of two or more layers having different constituting materials.

### (Transparent Substrate)

The materials constituting the transparent substrate 11 are not particularly limited so long as being transparent to light of the usage band, and can be appropriately selected according to the purpose.

For the present disclosure and scope of claims, “transparent relative to light of the usage band” does not indicate that the transmittance of light of the usage band is 100%, but rather indicates being a transmittance of light capable of maintaining the function as a polarizing element. For the light of the usage band, for example, visible light having a wavelength of at least 380 nm to no more than 810 nm or the like can be exemplified.

The materials constituting the transparent substrate 11 are not particularly limited; however, for example, materials having a refractive index of at least 1.1 and no more than 2.2 such as glass, crystal, quartz and sapphire can be exemplified. From the viewpoint of cost and light transmittance, quartz and glass are preferable, and quartz (refractive index 1.46) or soda lime glass (refractive index 1.51) are particularly preferable. In addition, from the viewpoint of thermal conductivity, crystal and sapphire are preferable. The heat resistance property of the transparent substrate 11 thereby improves, whereby it is possible to use as a polarizing element for the optical engine of a projector having high heat generation amount.

It should be noted that, as the materials constituting the transparent substrate 11, in the case of using a crystal having optical activity such as crystal and sapphire, it is preferable to arrange the latticed projection 12 in a parallel direction or perpendicular direction relative to the optical axis of the crystal. Superior optical properties are thereby obtained. Herein, optical axis is the directional axis in which the difference in the refractive index between O (ordinary ray) and E (extraordinary ray) of light propagating in this direction becomes the smallest.

The average thickness of the transparent substrate 11 is not particularly limited; however, for example, it is preferably at least 0.3 mm and no more than 1 mm. In addition, the shape of the main surface of the transparent substrate 11 is not particularly limited; however, for example, rectangular or the like can be exemplified.

### (Antireflection Layer)

It should be noted that the wire grid polarizing element 10 may further include an antireflection layer on the other surface of the transparent substrate 11.

The antireflection layer is formed on the transparent substrate 11, and is a multilayer form of two or more layers constituted by the same material as the material constituting the dielectric layer 12b. For example, a low refractive index layer and a high refractive index layer having different refractive indices can attenuate the light interface reflected by forming the antireflection layer laminated alternately.

The thickness of the antireflection layer is not particularly limited; however, for example, it is preferably at least 1 nm and no more than 500 nm. It should be noted that the measurement method for the thickness of the antireflection layer is not particularly limited; however, for example, electron microscopy or the like can be exemplified.

The antireflection layer can be formed as a high-density film by the same method as the dielectric layer 12b; however, from the viewpoint of the density of the antireflection layer, it is desirable to use the IAD method which is ion beam assisted (Ion-beam Assisted Deposition) or IBS method (Ion Beam Sputtering) as the formation method of the antireflection layer.

### (Protective Film)

The wire grid polarizing element 10 may be at least partially covered on the surface by a protective film. Herein, the materials constituting the protective film are the same as the materials constituting the dielectric layer 12b. The durability of the wire grid polarizing element 10 thereby improves.

The formation method of the protective film is not particularly limited; however, for example, the CVD method, ALD method, etc. can be exemplified. It should be noted that the protective film may be a layered body of two or more layers having different constituting materials, similarly to dielectric layer 12b.

### (Organic Water-Repellent Film)

The wire grid polarizing element 10 may be at least partially covered on a surface by an organic water-repellent film. The moisture resistance of the wire grid polarizing element 10 thereby improves.

The materials constituting the organic water-repellent film are not particularly limited; however, for example, a fluorine-based silane compound such as tridecafluorooctyl trichlorosilane (FOTS) can be exemplified.

The formation method of the organic water-repellent film is not particularly limited; however, for example, the CVD method, ALD method and the like can be exemplified.

### (Manufacturing Method of Wire Grid Polarizing Element)

The manufacturing method of the wire grid polarizing element 10 includes a step of forming a layered body by laminating, in order from the side of the transparent substrate 11 onto one surface of the transparent substrate 11, the reflection layer, dielectric layer and absorption layer; a step of forming the latticed projections 12 which extend in a predetermined direction, arranged at a pitch shorter than the wavelength of light in the usage band, by selectively etching the layered body; and a step of forming a division region 12d which divides the latticed projections 12 at a predetermined region of the transparent substrate 11.

Upon selectively etching the layered body, a mask pattern is formed.

The formation method of the mask pattern is not particularly limited; however, for example, the photolithography method, nanoimprint method and the like can be exemplified, for example.

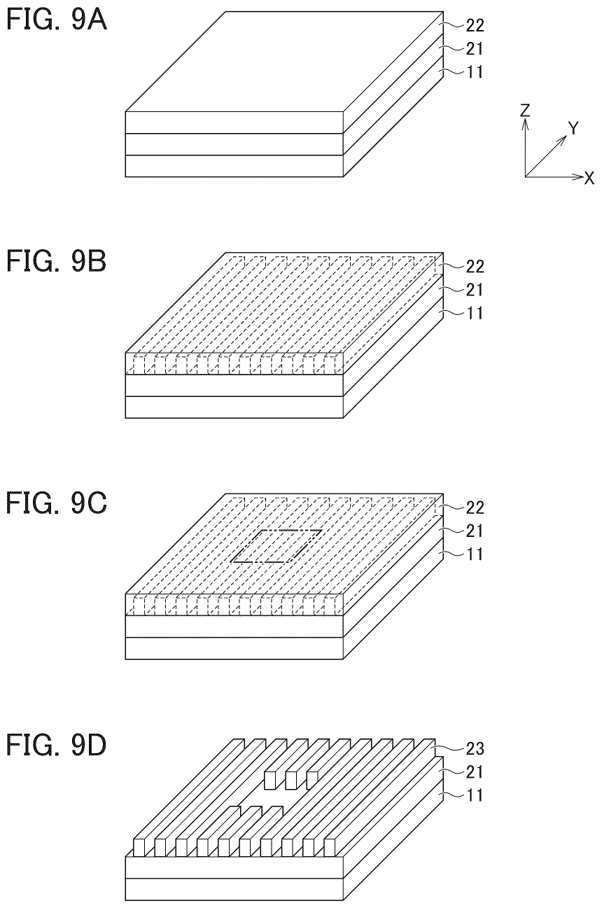

FIGS. 9A, 9B, 9C and 9D show an example of a formation method of the mask pattern. First, a resist 22 is formed on the layered body 21 (refer to FIG. 9A). Next, after exposing a region not corresponding to the latticed projection 12 of the resist 22 (refer to FIG. 9B), the rectangular region corresponding to the division region 12d of the resist 22 is exposed (refer to FIG. 9C). Next, the exposed part of the resist 22 is removed to form the mask pattern 23 (refer to FIG. 9D).

Next, a region of the layered body 21 in which the mask pattern 23 is not formed is etched.

The etching method is not particularly limited; however, for example, a dry etching method using etching gas that reacts with the etching target can be exemplified.

It should be noted that the manufacturing method of the wire grid polarizing element 10 may further include a step of forming an antireflection layer on the other surface of the transparent substrate 11. In addition, the manufacturing method of the wire grid polarizing element 10 may further include a step of covering at least part of the surface with a protective film, and may further include a step of covering at least part of the surface with an organic water-repellent film.

### (Optical Device)

An optical device according to the present embodiment includes the wire grid polarizing element according to the present embodiment.

The optical device according to the present embodiment is not particularly limited; however, for example, a liquid crystal display, a liquid crystal projector, a head-up display, a vehicle headlight and the like can be exemplified. Thereamong, a liquid crystal projector is preferable.

In the case of the optical device according to the present embodiment including a plurality of polarizing elements, it is sufficient if at least one of the plurality of polarizing elements is the wire grid polarizing element according to the present embodiment. For example, in the case of the optical device according to the present embodiment being a liquid crystal projector, it is sufficient if at least any of the polarizing elements arranged on the incident side or projection side of the liquid crystal panel is the wire grid polarizing element according to the present embodiment.

Although embodiments of the present invention have been explained above, the present invention is not to be limited to the above embodiments, and the above embodiments may be modified as appropriate within the scope of the gist of the present invention.

### EXPLANATION OF REFERENCE NUMERALS

10 wire grid polarizing element
11 transparent substrate
12 latticed projection
12a reflection layer
12b dielectric layer
12c absorption layer
12d division region
21 layered body
22 resist
23 mask pattern

1. A wire grid polarizing element comprising:
a transparent substrate; and
latticed projections arranged at a pitch shorter than a wavelength of light of a usage band on one surface of the transparent substrate, and extending in a predetermined direction,
wherein the latticed projection includes, in order from a side of the transparent substrate, a reflection layer, a dielectric layer and an absorption layer, and
wherein a region dividing the latticed projection is disposed in a predetermined region of the transparent substrate.

2. The wire grid polarizing element according to claim 1, wherein the transparent substrate is transparent to light of the usage band, and includes glass, crystal, quartz or sapphire.

3. The wire grid polarizing element according to claim 1, wherein the reflection layer contains at least one metal selected from the group consisting of Al, Ag, Cu, Mo, Cr, Ti, Ni, W, Fe, Si, Ge, Te and Nd.

4. The wire grid polarizing element according to claim 1, wherein the dielectric layer includes a Si oxide, a Ti oxide, a Zr oxide, an Al oxide, a Nb oxide or a Ta oxide.

5. The wire grid polarizing element according to claim 1, wherein the absorption layer absorbs light of the usage band, and contains a metal, alloy or semiconductor.

6. The wire grid polarizing element according to claim 1, further comprising an antireflection layer on another surface of the transparent substrate.

7. The wire grid polarizing element according to claim 1,
wherein at least part of a surface is covered by a protective film, and
wherein the protective film includes a material which is the same as the material included in the dielectric layer.

8. The wire grid polarizing element according to claim 1,
wherein at least part of a surface is covered by an organic water-repellent film.

9. A manufacturing method for a wire grid polarizing element, comprising the steps of: forming a layered body, by laminating on one surface of a transparent substrate in order from a side of the transparent substrate, a reflection layer, a dielectric layer and an absorption layer; and
forming latticed projections arranged at a pitch shorter than a wavelength of light of a usage band, and extending in a predetermined direction, by selectively etching the layered body,
forming a region dividing the latticed projection in a predetermined region of the transparent substrate.

10. The manufacturing method for a wire grid polarizing element according to claim 9, further comprising a step of forming an antireflection layer on another surface of the transparent substrate.

11. The manufacturing method for a wire grid polarizing element according to claim 9, further comprising a step of covering at least part of the surface by a protective film,
wherein the protective film includes a material that is the same as the material contained in the dielectric layer.

12. The manufacturing method for a wire grid polarizing element according to claim 9, further comprising a step of covering at least part of the surface by an organic water-repellent film.

13. An optical device comprising the wire grid polarizing element according to claim 1.
